(19) United States
(12) Patent Application Publication
(10) Pub. No.: US 2008/0110873 A1
(43) Pub. Date: May 15, 2008

(54) Apparatus and Method of Heating Food Products Using Two Heating Methods

(76) Inventor: Wei-Teh Ho, Taipei (TW)

Correspondence Address: KIRTON AND MCCONKIE, 60 EAST SOUTH TEMPLE,, SUITE 1800, SALT LAKE CITY, UT, 84111, US

(21) Appl. No.: 11/558,315

(22) Filed: Nov. 9, 2006

(51) Int. Cl. A21B 1/22

(52) U.S. Cl. 219/396

(57) ABSTRACT

An oven having a first heat source for heating a first heating bay and a second heat source for heating a second heating bay. The first heat source heats by conduction and may made up of a series of uniformly heated and rotating cylinder upon which a sausage-like food can be placed for heating or cooking. The second heat source is placed near the first heat source and heats by convection. The second heat source caramelizes the exterior of the food placed near it to create the appearance that the sausage was flame cooked.

### BACKGROUND

### Background of the Invention and Related Art

A variety of methods have been employed in cooking food products. For example radiant heating has been employed beginning with primitive people cooking food over an open fire. This method advanced, with the development of heating elements, to allow the cooking of food by placing the food in close proximity to the electrical heating elements. An alternative method of heating food products is placing the food products in direct contact with a heated surface. Advantages exist for each technique

### SUMMARY AND OBJECTS OF THE INVENTION

An exemplary embodiment comprising a first heat source in a first heating bay and a second heat source in a second heating bay, the first heat source heating by conduction, the second heat source heating by convection.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1—Provides a frontal view of an exemplary embodiment of the present invention.

FIG. 2—Provides a perspective view of an exemplary embodiment of the present invention.

### DETAILED DESCRIPTION OF THE PREFERRED EMBODIMENTS

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

This specification describes exemplary embodiments and applications of the invention. The invention, however, is not limited to these exemplary embodiments and applications or to the manner in which the exemplary embodiments and applications operate or are described herein.

Heating is defined as raising the temperature and may include cooking. Conduction heating is defined as heating by contact and may include cooking. Convection heating is defined as the transfer of radiant heat by currents of air or gases. Thus heating occurs by raising the ambient temperature. Heating may also include cooking and reheating.

Sausage is defined as a foodstuff including hot dogs, bratwurst, frankfurters etc.

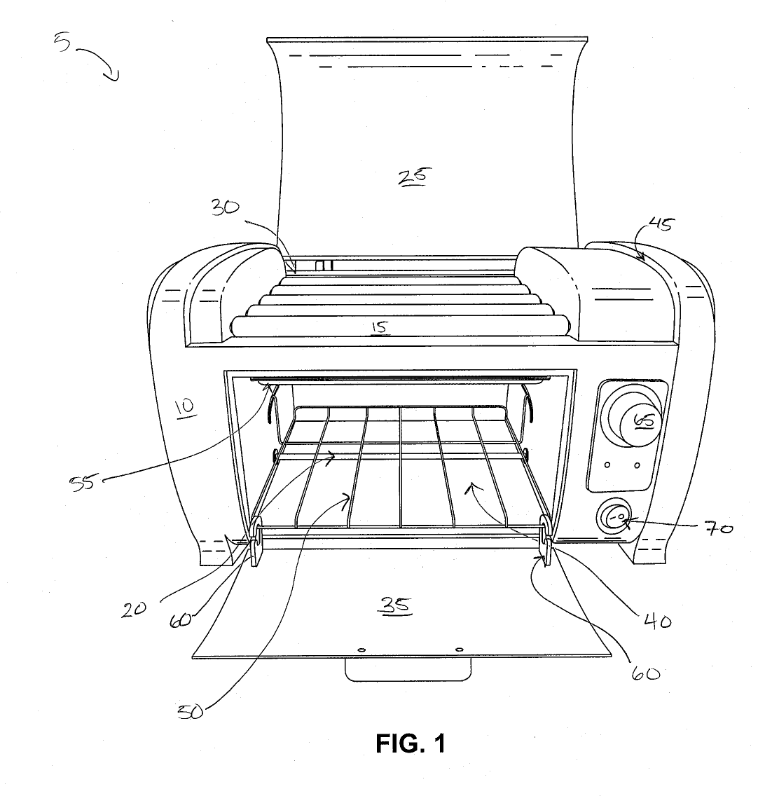

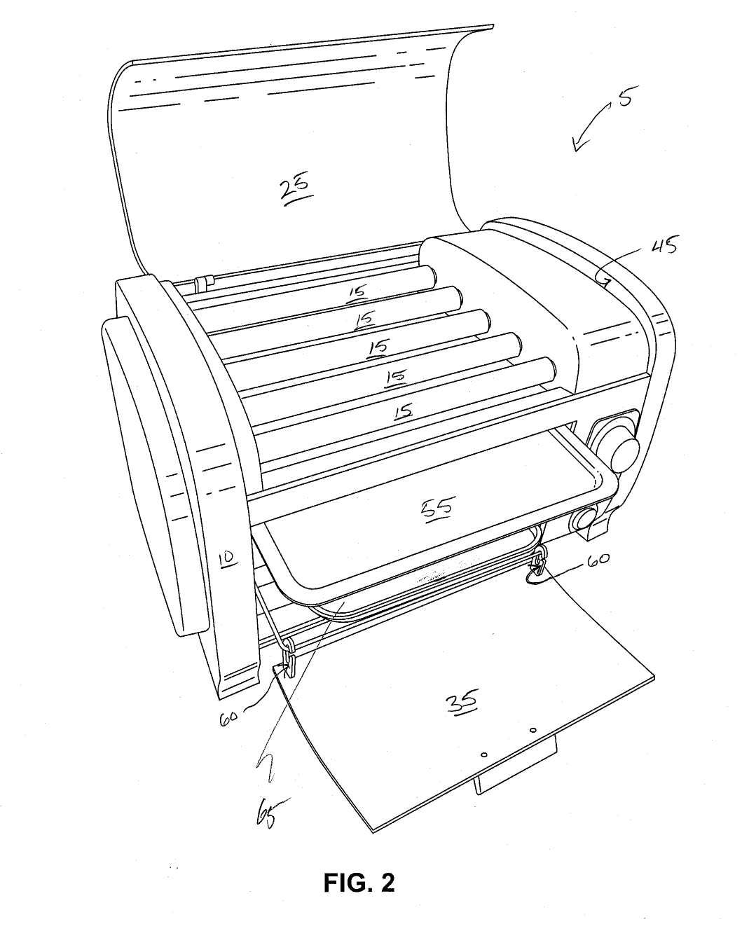

As shown in FIGS. 1-2, an exemplary embodiment comprises an oven 5 having a body 10 with a first heat source 15 and a second heat source 20. One or more heat sources may be controlled by electrical switch 70.

In an exemplary embodiment shown in FIGS. 1 and 2, the first heat source 15 may be a plurality of heated cylinders, each of which rotate. It is contemplated adjacent cylinders would rotate in the same direction and at a uniform speed. The cylinders are fixed in place and are not removable. The first heat source 15 heats an article of food, such as a sausage, by conduction and comes into direct contact with the sausage for the purpose of heating it. Similarly, the first heat source 15 rotates as described to uniformly heat the sausage without burning it. Thus when a sausage is placed on the first heat source 15, it rotates the food and heats it uniformly by the first heat source 15. The rotating cylinders may rotate continuously or at specified intervals depending on the type of sausage being heated and the desired heating. The first heat source 15 may heat a first heating bay 30 which may be enclosed by a hood 25 and the body walls 10. A sealing lip 45 forms a barrier between the hood 25 and the body 10 to minimize heat loss form the first heating bay.

The present invention also comprises a second heat source 20 which is a convection heat source. In an exemplary embodiment shown in FIGS. 1-2, a resistive element may be used as a source of radiant heat. As electricity passes through the resistive element of the second heat source, the element heats up and begins to radiate heat. The heat radiated from second heat source 20 heats a second heating bay 40 which is defined by the walls of the body 10 and a door 35. The second heating source is spaced a distance away form the first heat source such that the second heat source does not have a material heating/cooling effect on food items placed upon the first heat source.

There are several benefits to having two alternate heat sources in a combined unit. First, different foods are best heated using different heat sources i.e. sausages are best heated using conduction, while bread buns are best heated using convection. In addition, when food items are placed on rack 60, the convection heat source in the body 10 singes the exterior surface of the food items such as sausages, giving them a flavor and texture preferable to some over simple reheating. The radiant heat may caramelize the exterior of the sausages to give them the flavor and appearance of flame broiled. In addition, the convection heat source can reduce the relative humidity in the oven, thus preventing the bread buns from becoming soggy after being placed in the oven with the cooking sausages. Similarly, bread buns can also be toasted over the convection heat source which may be preferable to simple steam heating.

Additional features are utilized in the preferred exemplary embodiment. A rack 50 may be used in the second heating bay 40 to support food items during heating in second bay 40. Similarly, a food tray 65 may be used in bay 40. Similarly, a removable tray 55 may be utilized under first heat source 15 to catch grease and other fluids escaping from the food items while heated on the first heat source 15. Tray member 55 slides laterally into the oven between the first and second heating bays. In the illustrated embodiment, tray 55 is the only separation between the first heating bay 30 and second heating bay 40. In another embodiment, housing 10 could extend between bays 30 and 40. If desired, tray 55 may also be used to shield the food items from too much heat being radiated from the second heat source 20.

In the exemplary embodiments, the first heat source 15 is not removable, but is fixed in the body 10. Removable tray 55 facilitates access for cleaning. The door 35 may have couplers 55 connecting the door to a rack 60 located in the second heating bay 40. The couplers 55 draw the rack 60 out of the second heating bay 40 to improve access to the contents of heating bay 40.

A timer 65 may be included to notify a user when the food heating is complete. The timer 65 may be a simple spring loaded timer or a more complex electric timer with sensors proximate the food to determine when the heating process is complete.

What is claimed:

1. An oven comprising:
a first heat source comprising a conduction heating element; and
a second heat source comprising a convection heating element.

2. The oven of claim 1 further comprising a first heating bay having the first heat source therein.

3. The oven of claim 1 further comprising a second heating bay having the second heat source therein.

4. The first heat source of claim 1 wherein the heat source is a rotating cylinder.

5. The oven of claim 1 wherein the second heat source is located under the first heat source.

6. The oven of claim 1 further comprising a heat-maintaining hood to cover the opening of the first heating bay.

7. The oven of claim 1 further comprising a heat-maintaining door to cover the opening of the second heating bay.

8. The heat maintaining-door of claim 7 further comprising coupling members to draw a rack laterally within the second heating bay.

9. The first heat source of claim 1 wherein the first heat source comprises heated cylinders.

10. An oven comprising a plurality of heated rollers in a first heating bay adjacent a source of radiant heat in a second heating bay, the first heating bay and the second heating bay being separated by a removable member.
